(19) United States
(12) Patent Application Publication
(10) Pub. No.: US 2025/0021373 A1
(43) Pub. Date: Jan. 16, 2025

(54) CONTROLS, SERVERS, CONTROL SYSTEMS, AND CONTROL METHODS

(71) Applicant: NIPPON TELEGRAPH AND TELEPHONE CORPORATION, Tokyo (JP)

(72) Inventors: Sei KOU, Musashino-shi (JP); Takashi YAMADA, Musashino-shi (JP); Tomoya HATANO, Musashino-shi (JP)

(73) Assignee: NIPPON TELEGRAPH AND TELEPHONE CORPORATION, Tokyo (JP)

(21) Appl. No.: 18/712,021

(22) PCT Filed: Nov. 25, 2021
(86) PCT No.: PCT/JP2021/043205

§ 371 Date: May 21, 2024

(51) Int. Cl. G06F 9/455

(52) U.S. Cl. CPC G06F 9/45558; G06F 2009/4557

(57) ABSTRACT

A control device includes an activation unit configured to cause another virtual machine or another container to activate an application that is activated in a virtual machine or a container constructed in a server and periodically transmits control information to a control target device, a communication setting unit configured to perform, in a case where the application has been activated, setting for enabling communication between the activated application and the control target device, and a deriving unit configured to derive, as a timing at which the activation unit activates the application, a timing at which the setting is not performed between transmission of the control information from the application and reception of the control information by the control target device, wherein the activation unit causes the another virtual machine or the another container to activate the application at the derived timing.

### TECHNICAL FIELD

The present invention relates to controls, servers, control systems, and control methods.

### BACKGROUND ART

For economization of Internet of Things (IoT), there is an application that performs processing on various types of information transmitted from a control target device such as an IoT device and periodically transmits a control signal to the control target device to control the control target device using an edge cloud or the like. Such an application is activated in, for example, a virtual machine (VM) or a container having high-performance resources as illustrated in FIG. 11.

In this case, in response to a certain server M having a high load or performing system maintenance on the server M, the application may be migrated to another server N, and thus the application may be activated in the server N. In view of such a background, a technique of migration for a container or the like has been proposed (see Non Patent Literature 1).

### CITATION LIST

### Non Patent Literature

Non Patent Literature 1: Puliafito, C., Vallati, C., Mingozzi, E., Merlino, G., Longo, F., & Puliafito, A. (2019). Container migration in the fog: A performance evaluation. Sensors, 19(7), 1488.

### SUMMARY OF INVENTION

### Technical Problem

In a case where the application is activated by performing migration from the server M to the server N, a control signal may not reach a control target device depending on the activation timing. This will be described in detail with reference to FIG. 12. FIG. 12 is a diagram illustrating a timing chart. In FIG. 12, a timing Ta indicates a timing at which the application has transmitted a control signal. A timing Tb indicates a timing at which the control signal has been output from a VM or a container. A timing Tc indicates a timing at which a control target device has received the control signal.

As illustrated in FIG. 12, the application is activated in the server N by performing migration to the server N. Thereafter, in a case where a communication path between the application and the control target device has been switched at the timings Ta, Tb, and Tc, a packet is lost and thus the control signal may not reach the control target device.

In view of the above circumstances, an object of the present invention is to provide a technique for preventing a control signal from not reaching its target.

### Solution to Problem

One aspect of the present invention is a control device including: an activation unit configured to cause another virtual machine or another container to activate an application that is activated in a virtual machine or a container constructed in a server and periodically transmits control information to a control target device; a communication setting unit configured to perform, in a case where the application has been activated by the activation unit in the another virtual machine or the another container, setting for enabling communication between the activated application and the control target device; and a deriving unit configured to derive, as a timing at which the activation unit activates the application, a timing at which the setting by the communication setting unit is not performed between transmission of the control information from the application and reception of the control information by the control target device, wherein the activation unit causes the another virtual machine or the another container to activate the application at the timing derived by the deriving unit.

One aspect of the present invention is a server including: an activation unit configured to activate an application for transmitting control information to a control target device in a virtual machine or a container in accordance with an instruction from a control device; and a notification unit configured to notify the control device of a transmission timing at which the application has transmitted control information to the control target device and a reception completion timing at which the control information has been received by the control target device.

One aspect of the present invention is a control system including a control device and a server, the control device including: an activation unit configured to cause another virtual machine or another container to activate an application that is activated in a virtual machine or a container constructed in a server and periodically transmits control information to a control target device; a communication setting unit configured to perform, in a case where the application has been activated by the activation unit in the another virtual machine or the another container, setting for enabling communication between the activated application and the control target device; and a deriving unit configured to derive, as a timing at which the activation unit activates the application, a timing at which the setting by the communication setting unit is not performed between transmission of the control information from the application and reception of the control information by the control target device, wherein the activation unit causes the another virtual machine or the another container to activate the application at the timing derived by the deriving unit, the server including: an activation instruction receiving unit configured to activate the application in a virtual machine or a container in accordance with an instruction from the control device; and a notification unit configured to notify the control device of a transmission timing at which the application has transmitted the control information and a reception completion timing at which the control information has been received by the control target device.

One aspect of the present invention is a control method including: an activation step of causing another virtual machine or another container to activate an application that is activated in a virtual machine or a container constructed in a server and periodically transmits control information to a control target device; a communication setting step of performing, in a case where the application has been activated in the activation step in the another virtual machine or the another container, setting for enabling communication between the activated application and the control target device; and a deriving step of deriving, as a timing at which the activation step activates the application, a timing at which the setting in the communication setting step is not performed between transmission of the control information from the application and reception of the control information by the control target device, wherein the activation step causes the another virtual machine or the another container to activate the application at the timing derived in the deriving step.

One aspect of the present invention is a control method including: an activation step of activating an application for transmitting control information to a control target device in a virtual machine or a container in accordance with an instruction from a control device; and a notification step of notifying the control device of a transmission timing at which the application has transmitted control information to the control target device and a reception completion timing at which the control information has been received by the control target device.

One aspect of the present invention is a control method in a control system comprising a control device and a server, the control device including: an activation step of causing another virtual machine or another container to activate an application English Translation of that is activated in a virtual machine or a container constructed in a server and periodically transmits control information to a control target device; a communication setting step of performing, in a case where the application has been activated in the activation step in the another virtual machine or the another container, setting for enabling communication between the activated application and the control target device; and a deriving step of deriving, as a timing at which the activation step activates the application, a timing at which the setting in the communication setting step is not performed between transmission of the control information from the application and reception of the control information by the control target device, wherein the activation step causes the another virtual machine or the another container to activate the application at the timing derived in the deriving step, the server including: an activation instruction receiving step of activating the application in a virtual machine or a container in accordance with an instruction from the control device; and a notification step of notifying the control device of a transmission timing at which the application has transmitted the control information and a reception completion timing at which the control information has been received by the control target device.

### Advantageous Effects of Invention

According to the present invention, it is possible to prevent a control signal from not reaching its target.

### BRIEF DESCRIPTION OF DRAWINGS

FIG. 1 is a diagram illustrating a configuration example including a control system.

FIG. 2 is a timing chart illustrating a list of patterns that can prevent a control signal from not reaching its target.

FIG. 3 is a diagram illustrating a configuration example of a control device.

FIG. 4 is a diagram illustrating a configuration example of a server.

FIG. 5 is a diagram illustrating a configuration example of a control target device.

FIG. 6 is a flowchart illustrating a flow of processing of both patterns A and B1.

FIG. 7 is a flowchart illustrating a flow of processing of a pattern B2.

FIG. 8 is a diagram illustrating a configuration example of a control device.

FIG. 9 is a flowchart illustrating a flow of processing of both patterns C and D.

FIG. 10 is a diagram illustrating a configuration example of a non-linear compensation unit in a case where a total of M pieces of channel distribution information are output from a channel distribution estimation unit.

FIG. 11 is a diagram illustrating a configuration example in a conventional technique.

FIG. 12 is a diagram illustrating a timing chart in the conventional technique.

### DESCRIPTION OF EMBODIMENTS

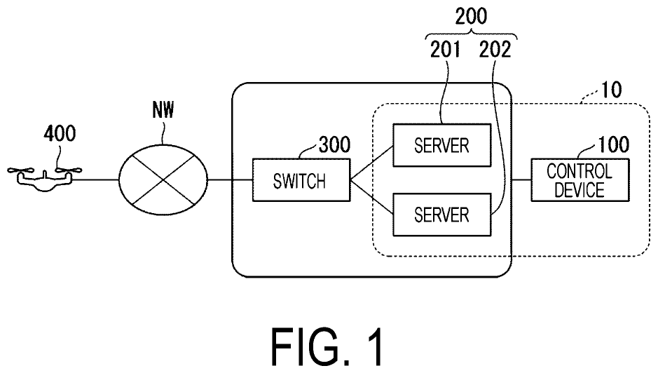

Embodiments of the present invention will be described in detail with reference to the drawings. FIG. 1 is a diagram illustrating a configuration example including a control system 10 according to the present embodiment. FIG. 1 illustrates a control device 100, servers 201 and 202, a switch 300, a network NW, and a control target device 400.

The control device 100 performs various controls on the servers 201 and 202 and the switch 300. Specifically, the control device 100 performs control such as activating an application by performing migration from the server 201 to the server 202 or switching a path of the switch 300. The application according to the present embodiment periodically transmits a control signal to the control target device 400. In addition, the application is activated in a virtual machine (VM) or a container constructed in the servers 201 and 202 as will be described later.

The servers 201 and 202 can construct a VM or a container. Although two servers are shown as an example in the present embodiment, three or more servers may be provided. In a case where the servers 201 and 202 are not particularly distinguished, they are referred to as a server 200.

The switch 300 switches the communication path of the control target device 400 to the server 201 or the server 202 under the control of the control device 100. The network NW is a network that connects the control target device 400 and the server 200. Although the control target device 400 is a drone as an example in FIG. 1, the control target device 400 may be any device that can be controlled by the application.

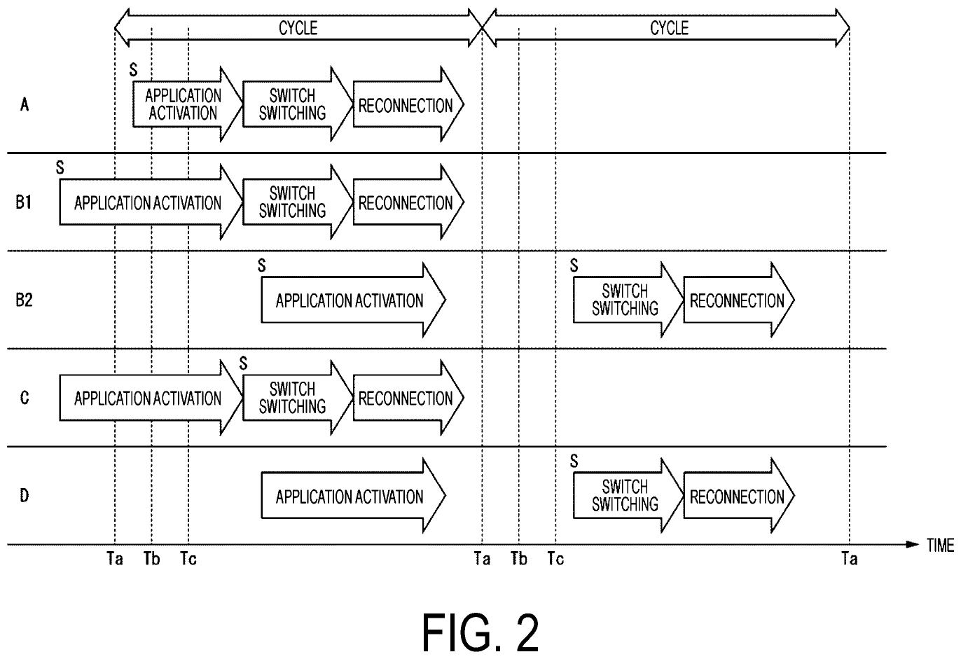

FIG. 2 is a timing chart illustrating a list of patterns (A, B1, B2, C, D) that can prevent a control signal from not reaching its target even in a case where migration is performed. In FIG. 2, the horizontal axis represents time. Further, “S” indicates a timing derived in the control device 100 (an activation timing and a setting timing which will be described later).

“Application activation” indicates application activation processing. “Switch switching” indicates processing of switching a path of the switch 300. “Reconnection” indicates connection processing for enabling communication between the activated application and the control target device 400. A series of processes including path switching processing and reconnection processing is referred to as communication setting processing.

In FIG. 2, a timing Ta indicates a timing at which the application has transmitted a control signal. Tb indicates a timing at which the control signal has been output from a VM or a container. Tc indicates a reception completion timing at which the control target device 400 has received the control signal. There are two methods for acquiring the timing Tc. One method is a method of setting the timing Tc as a timing at which a response such as ACK to the control signal has been returned from the control target device 400. The other is a method of ascertaining a network delay time from transmission of the control signal to arrival thereof at the control target device 400 in advance and setting a timing obtained by adding the network delay time to the control signal transmission timing. The three timings Ta, Tb, and Tc are collectively referred to as a communication timing.

In the present embodiment, the period from the timing Ta to the next timing Ta is one cycle. In addition, as a premise, the communication setting processing can be completed between the timing Tc and the timing Ta. Therefore, it is possible to prevent the control signal from not reaching its target by setting a start timing of the communication setting processing to a timing at which the communication timing does not arrive during the communication setting processing.

In the present embodiment, the patterns are roughly classified into two and will be described as two embodiments. In the first embodiment, control based on a time (hereinafter, referred to as “total time”) from the start of the activation processing to the end of the communication setting processing will be described. In the second embodiment, control based on a time from the start of the communication setting processing to the end of the communication setting processing separately from the activation processing, that is, the communication setting processing time will be described. Among the patterns described above, the patterns A, B1, and B2 will be described in the first embodiment. The patterns C and D will be described in the second embodiment. Hereinafter, each embodiment will be described.

### First Embodiment

The pattern A illustrated in FIG. 2 is a pattern in which the total time falls within one cycle. Therefore, it is possible to prevent the control signal from not reaching its target by deriving a timing at which the communication timing does not arrive during the communication setting processing as a start timing of the activation processing.

Patterns B1 and B2 illustrated in FIG. 2 are patterns in which the total time does not fall within one cycle. Even in this case, it is possible to prevent the control signal from not reaching its target by deriving the timing at which the communication timing does not arrive during the communication setting processing as the start timing of the activation processing.

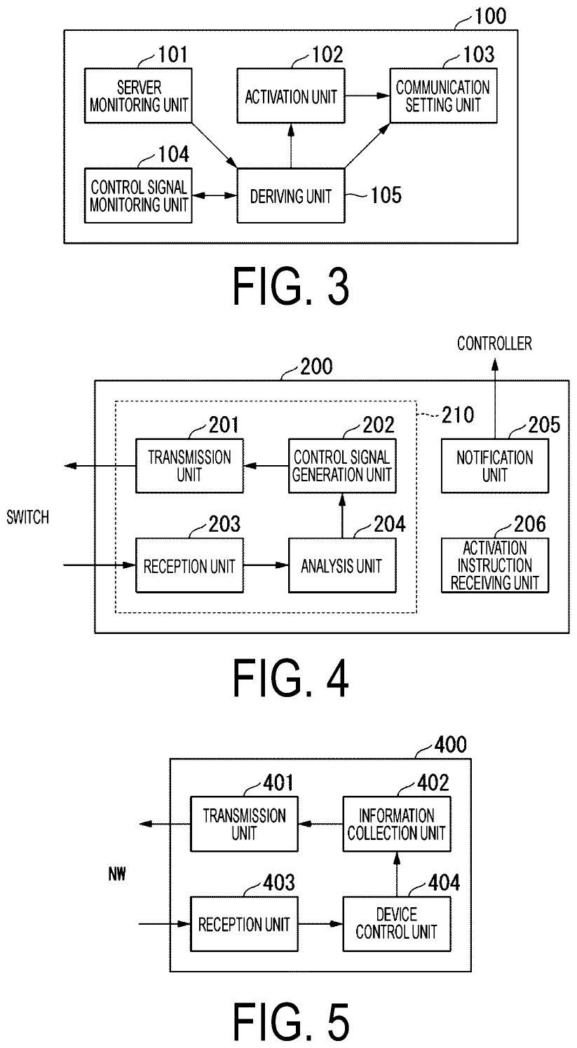

A configuration example of the first embodiment will be described. FIG. 3 is a diagram illustrating a configuration example of the control device 100. The control device 100 includes a server monitoring unit 101, an activation unit 102, a communication setting unit 103, a control signal monitoring unit 104, and a deriving unit 105.

The server monitoring unit 101 acquires a status such as a resource usage rate from the server 201. In the case of the patterns A and B1, the deriving unit 105 is instructed to derive an activation timing to activate the application in the server 202 when a state in which migration of the application is required, such as the server 201 having a high load, is detected according to an acquired status. In the case of the pattern B2, the server monitoring unit 101 instructs the deriving unit 105 to derive an activation timing to activate in the server 202 and a setting timing to start the communication setting processing. When the activation timing arrives, the activation unit 120 causes a virtual machine or a container constructed in the server 202 to activate the application

The control signal monitoring unit 104 acquires the above-described communication timing (Ta, Tb, and Tc) from the server 200. The control signal monitoring unit 104 can predict a cycle or a time at which an incoming communication timing will occur by acquiring a communication timing a plurality of times. The cycle or the time at which the communication timing occurs is output to the deriving unit 105.

The deriving unit 105 derives, as a timing at which the activation unit 102 activates the application, a timing at which setting by the communication setting unit 103 is not performed between transmission of control information from the application (timing Ta) and reception of the control information by control target device 400 (timing Tc). At this time, the timing is derived on the basis of the cycle or the time at which the communication timing occurs.

The communication setting unit 103 performs setting for enabling communication between the activated application and the control target device 400 in a case where the application is activated in another virtual machine or another container by the activation unit 102 or in a case where a setting timing has arrived.

FIG. 4 is a diagram illustrating a configuration example of the server 200. The server 200 includes an application 210, a notification unit 205, and an activation instruction receiving unit 206. Further, the application 210 includes a transmission unit 201, a control signal generation unit 202, a reception unit 203, and an analysis unit 204.

The reception unit 203 receives various types of information from the control target device 400 and outputs the information to the analysis unit 204. The analysis unit 204 analyzes various types of information acquired by the reception unit 203 and outputs required information to the control signal generation unit 202. The control signal generation unit 202 generates a control signal on the basis of the information output from analysis unit 204 and outputs the control signal to the transmission unit 201. The transmission unit 201 transmits the control signal generated by the control signal generation unit 202 to the control target device 400.

Upon receiving an instruction from the control device 100, the activation instruction receiving unit 206 activates the application in the virtual machine or the container. The notification unit 205 notifies the control signal monitoring unit 104 of the control device 100 of the communication timings (Ta, Tb, and Tc). In addition, the notification unit 205 notifies the server monitoring unit 101 of the control device 100, of the load of the server 200.

FIG. 5 is a diagram illustrating a configuration example of the control target device 400. The control target device 400 includes a transmission unit 401, an information collection unit 402, a reception unit 403, and a device control unit 404. The reception unit 403 receives a control signal from the application 210 and outputs the control signal to the device control unit 404. The device control unit 404 performs control of the entire device such as selection of a behavior of the control target device 400, information to be collected, and information to be transmitted to the application 210. The information collection unit 402 collects various types of information and outputs the information to the transmission unit 401. The transmission unit 401 transmits various types of information to the application 210.

A flow of processing in the first embodiment will be described using a flowchart. “APP” written in the flowchart indicates an application. In the patterns A and B1, an activation timing is derived as described in FIG. 2, and in the pattern B2, both the activation timing and a setting timing are derived. Therefore, a flowchart illustrating a flow of processing of both the patterns A and B1 and a flowchart illustrating a flow of processing of the pattern B2 will be described.

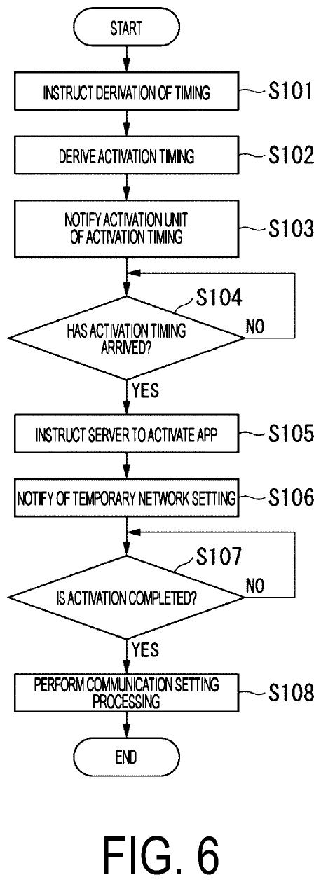

FIG. 6 is a flowchart illustrating a flow of processing of both the patterns A and B1. In a case where migration is required, such as a case where the load of the server 201 exceeds a threshold value, the server monitoring unit 101 instructs the deriving unit 105 to derive a timing (step S101). The deriving unit 105 derives an application activation timing (step S102). Here, the deriving unit 105 derives an application activation timing at which communication setting processing is completed before the timing Ta on the basis of a cycle or a time at which a communication timing occurs. As a result, a timing at which setting by the communication setting unit 103 is not performed between transmission of control information from the application (timing Ta) and reception of the control information by the control target device 400 (timing Tc) is derived. The deriving unit 105 notifies the activation unit 102 of the derived activation timing.

The activation unit 102 determines whether or not the notified activation timing has arrived (step S104). When the activation timing has arrived (step S104: YES), the activation unit 102 instructs the server 202 to activate the application (step S105). Subsequently, the communication setting unit 103 notifies the switch 300 of temporary network setting in accordance with an instruction from the activation unit 102 (step S106). The temporary network setting is a setting in which various types of information transmitted from the control target device 400 to the application of the server 201 are also transmitted to the application of the server 202 by mirroring. As a result, the activated application of the server 202 can also receive various types of information and generate a control signal.

The communication setting unit 103 determines whether or not activation of the application of the server 202 is completed (step S107). If the application is activated (step S107: YES), the communication setting unit 103 starts communication setting processing (step S108). Here, the communication setting unit 103 ends the temporary network setting, switches the path of the switch 300, and reconnects the application of the server 202 and the control target device 400 such that they can communicate.

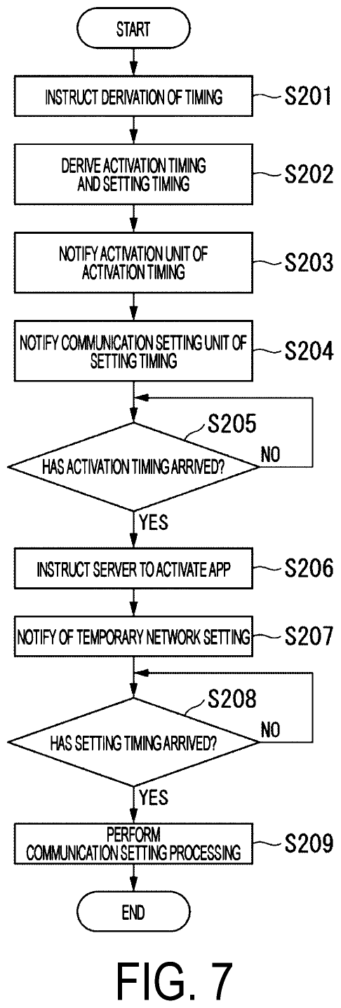

FIG. 7 is a flowchart illustrating a flow of processing of the pattern B2. In a case where migration is required, such as a case where the load of the server 201 exceeds a threshold value, the server monitoring unit 101 instructs the deriving unit 105 to derive a timing (step S201). The deriving unit 105 derives an activation timing and a setting timing such that activation of the application and communication setting processing are performed at different cycles (step S202).

Here, the deriving unit 105 first derives the activation timing. Specifically, in a case where the activation processing and the communication setting processing have continuously been performed, the deriving unit 105 derives an application activation timing at which the communication setting processing is completed before the timing Ta. For example, in a case where the activation processing and the communication setting processing have continuously been performed, there is an activation timing at which the communication setting processing is performed immediately after the timing Tc. Further, the deriving unit 105 derives an application activation timing at which the communication setting processing is completed before timing Ta on the basis of the derived activation timing and the cycle or the time at which the communication timing occurs. As a result, a timing at which setting by the communication setting unit 103 is not performed between transmission of control information from the application (timing Ta) and reception of the control information by the control target device 400 (timing Tc) is derived.

The deriving unit 105 notifies the activation unit 102 of the derived activation timing (step S203) and notifies the communication setting unit 103 of the setting timing (step S204).

The activation unit 102 determines whether or not the notified activation timing has arrived (step S205). When the activation timing has arrived (step S205: YES), the activation unit 102 instructs the server 202 to activate the application (step S206). Subsequently, the communication setting unit 103 notifies the switch 300 of the above-described temporary network setting in accordance with an instruction from the activation unit 102 (step S207).

The communication setting unit 103 determines whether or not the setting timing has arrived (step S208). When the setting timing has arrived (step S208: YES), the communication setting unit 103 starts the communication setting processing (step S209). Here, the communication setting unit 103 ends the temporary network setting, switches the path of the switch 300, and reconnects the application of the server 202 and the control target device 400 such that they can communicate.

As described above, in any of the patterns A, B1, and B2, a timing at which setting by the communication setting unit 103 is not performed between transmission of control information from the application (timing Ta) and reception of the control information by the control target device 400 (timing Tc) is derived. This makes it possible to prevent a control signal from not reaching its target.

### Second Embodiment

Both the patterns C and D illustrated in FIG. 2 are patterns in which the total time does not fall within one cycle. Even in this case, it is possible to prevent a control signal from not reaching its target by deriving a timing at which a communication timing does not arrive during communication setting processing as a start timing of the communication setting processing.

A configuration example of the second embodiment will be described. A configuration of the second embodiment different from the configuration of the first embodiment is the configuration of the control device 100. Therefore, only the configuration of the control device 100 will be described, and the description of other configurations will be omitted.

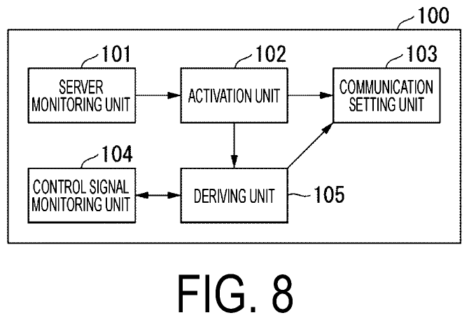

FIG. 8 is a diagram illustrating a configuration example of the control device 100. The control device 100 includes a server monitoring unit 101, an activation unit 102, a communication setting unit 103, a control signal monitoring unit 104, and a deriving unit 105.

The server monitoring unit 101 acquires a status such as a resource usage rate from the server 201. When a state in which migration of an application is required, such as the server 201 having a high load, is detected according to an acquired status, the activation unit 102 is instructed to activate the application in the server 202. The activation unit 120 causes a virtual machine or a container constructed in the server 202 to activate the application according to an instruction from the server monitoring unit 101. When activation of the application is completed, the activation unit 120 instructs the deriving unit 105 to derive a setting timing.

The control signal monitoring unit 104 acquires the above-described communication timing (Ta, Tb, and Tc) from the server 200. The control signal monitoring unit 104 can predict a cycle or a time at which an incoming communication timing will occur by acquiring a communication timing a plurality of times. The cycle or the time at which the communication timing occurs is output to the deriving unit 105.

Deriving unit 105 derives, as the setting timing, a timing at which setting for enabling communication can be completed between reception of control information transmitted from the application by the control target device 400 (timing Tc) and transmission of the next control information (timing Ta). At this time, the timing is derived on the basis of the cycle or the time at which the communication timing occurs.

In a case where the setting timing has arrived, the communication setting unit 103 performs setting for enabling communication between the activated application and the control target device 400.

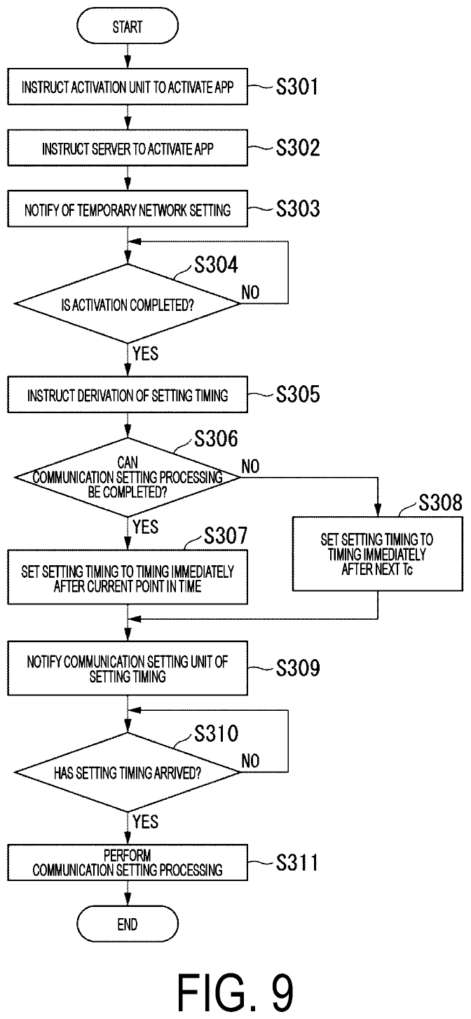

A flow of processing in the second embodiment will be described using a flowchart. FIG. 9 is a flowchart illustrating a flow of processing of both the patterns C and D. When migration is required, for example, when the load of the server 201 exceeds a threshold value, the server monitoring unit 101 instructs the activation unit 102 to activate the application (step S301).

The activation unit 102 instructs the server 202 to activate the application (step S302). Subsequently, the communication setting unit 103 notifies the switch 300 of temporary network setting in accordance with an instruction from the activation unit 102 (step S303). The activation unit 102 determines whether or not activation of the application of the server 202 is completed (step S304). If the application is activated (step S304: YES), the activation unit 102 instructs the deriving unit 105 to derive a setting timing (step S305).

In a case where communication setting process is performed immediately after the current point in time, the deriving unit 105 determines whether or not the communication setting processing can be completed before the timing Ta (step S306). If the communication setting processing can be completed before the timing Ta (step S306: YES), deriving unit 105 sets the setting timing to a timing immediately after the current point in time (step S307) and notifies the communication setting unit 103 of the setting timing (step S309).

If the communication setting processing cannot be completed before the timing Ta (step S306: NO), deriving unit 105 sets the setting timing to a timing immediately after the next timing Tc of the current point in time (step S308) and notifies communication setting unit 103 of the setting timing (step S309).

The communication setting unit 103 determines whether or not the setting timing has arrived (step S310). When the setting timing has arrived (step S310: YES), the communication setting unit 103 starts the communication setting processing (step S311). Here, the communication setting unit 103 ends the temporary network setting, switches the path of the switch 300, and reconnects the application of the server 202 and the control target device 400 such that they can communicate.

As described above, in either of the patterns C and D, the timing at which setting for enabling communication can be completed between reception of the control information transmitted from the application by the control target device 400 (timing Tc) and transmission of the next control information (timing Ta) is derived. This makes it possible to prevent a control signal from not reaching its target.

(Case where there is a Plurality of Control Target Devices)

Although one control target device 400 has been described in the first embodiment and the second embodiment in order to simplify the description, each embodiment can be applied even when there is a plurality of control target devices. In general, in a case where there is a plurality of control target devices, timings and cycles at which control information is transmitted are different.

Therefore, as a timing at which the communication setting unit 103 starts setting for enabling communication, the deriving unit 105 derives a timing at which setting for enabling communication can be completed between reception of control information transmitted from an application by the control target devices and transmission of the next control information in all the control target devices.

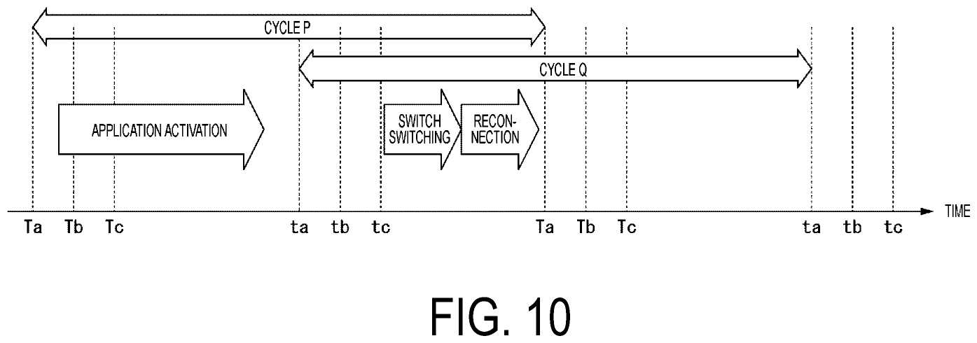

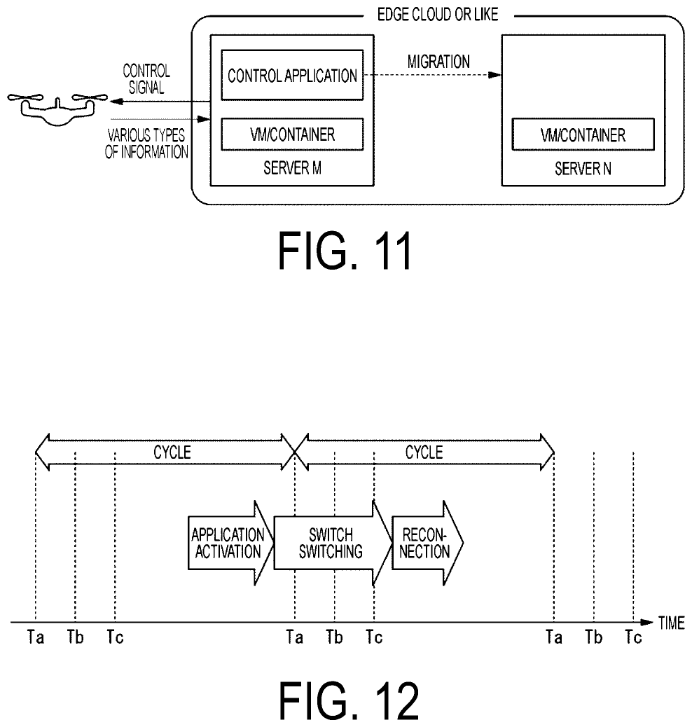

This will be specifically described with reference to FIG. 10. FIG. 10 illustrates an example of two control target devices P and Q. A cycle P indicates a cycle corresponding to the control target device P. A cycle Q indicates a cycle corresponding to the control target device Q.

A timing Ta indicates a timing at which an application that controls the control target device P has transmitted a control signal. A timing Tb indicates a timing at which the control signal to the control target device P has been output from a VM or a container. A timing Tc indicates a timing at which the control target device P has received the control signal.

A timing ta indicates a timing at which an application that controls the control target device Q has transmitted a control signal. A timing tb indicates a timing at which the control signal to the control target device Q has been output from the VM or the container. A timing tc indicates a timing at which the control target device Q has received the control signal.

As illustrated in FIG. 10, in all the control target devices, the timing at which setting for enabling communication can be completed between reception of the control information transmitted from the applications by the control target devices and transmission of the next control information is a timing between tc and the next Ta. In this manner, the setting timing is derived in a time zone in which a time required for the communication setting processing can be secured. In this case, the setting timing is, of course, set to a timing at which the communication setting processing can be completed within the above time zone.

In a case where there is no time zone in which the time required for the communication setting processing can be secured, it is also possible to cope with a case where there is a plurality of control target devices by applying the first embodiment or the second embodiment described above to the control target devices one by one. For example, in a case where an application A operating in a virtual machine X controls control target devices S and T, the first embodiment or the second embodiment described above is applied to the control target device S and the application A. At this time, the virtual machine X is operated as it is in order to cause the application A to control the control target device T. After the first embodiment or the second embodiment described above is applied to the control target device S and the application A, the first embodiment or the second embodiment described above is applied to the control target device T and the application A. In this way, it is also possible to cope with a case where there is a plurality of control target devices.

Although the two servers 201 and 202 have been described as an example in the first embodiment and the second embodiment, the application in the present embodiment can also be applied to a case of migration to a different virtual machine or container constructed in one server since the application is activated in a virtual machine or a container. In the case of migration to a different virtual machine or container constructed in one server, the deriving unit 105 derives, as a timing at which the activation unit 102 activates the application, a timing at which setting by the communication setting unit 103 is not performed between transmission of control information from the application (timing Ta) and the timing (timing Tb) at which the control signal has been output from the VM or the container in the first embodiment and the second embodiment described above. Further, in the second embodiment, the deriving unit 105 derives, as a start timing of the communication setting processing, a timing at which setting by the communication setting unit 103 is not performed between transmission of the control information from the application (timing Ta) and the timing (timing Tb) at which the control signal has been output from the VM or the container.

Further, the present invention can be applied not only to migration between servers in the same cloud but also to migration between servers in different edge clouds. In addition, in one server, migration due to a high load of partial hardware resources (graphics processing unit (GPU), field programmable gate array (FPGA), and the like) can also be applied.

Each function of the control device 100 and the server 200 may be realized using a processor such as a central processing unit (CPU) and a memory. In this case, each function of the control device 100 and the server 200 is executed in the control device 100 and the server 200 by the processor executing a program. All or some of the functions of the control device 100 and the server 200 may be realized by using hardware such as an application specific integrated circuit (ASIC), a programmable logic device (PLD), or a field programmable gate array (FPGA). The program may be recorded in a computer-readable recording medium. The computer-readable recording medium is, for example, a portable medium such as a flexible disc, a magneto-optical disk, a ROM, a CD-ROM, or a semiconductor storage device (for example, a solid state drive (SSD)), or a storage device such as a hard disk or a semiconductor storage device built in a computer system. The aforementioned program may be transmitted via a telecommunication line.

Although the embodiments of the present invention have been described in detail with reference to the drawings, a specific configuration is not limited to the embodiments, and includes design and the like without departing from the spirit of the present invention.

### INDUSTRIAL APPLICABILITY

The present invention is applicable to a migration technology.

### REFERENCE SIGNS LIST

10 Control system
100 Control device
101 Server monitoring unit
102 Activation unit
103 Communication setting unit
104 Control signal monitoring unit
105 Deriving unit
120 Activation unit
200, 201, 202 Server
203 Reception unit
204 Analysis unit
205 Notification unit
206 Activation instruction receiving unit
210 Application
300 Switch
400 Control target device
401 Transmission unit
402 Information collection unit
403 Reception unit
404 Device control unit

1. A control device comprising:
an activator configured to cause another virtual machine or another container to activate an application that is activated in a virtual machine or a container constructed in a server and periodically transmits control information to a control target device;
a communication setter configured to perform, in a case where the application has been activated by the activator unit in the another virtual machine or the another container, setting for enabling communication between the activated application and the control target device; and
a deriver configured to derive, as a timing at which the activator activates the application, a timing at which the setting by the communication setter is not performed between transmission of the control information from the application and reception of the control information by the control target device,
wherein the activator causes the another virtual machine or the another container to activate the application at the timing derived by the deriver unit.

2. The control device according to claim 1, wherein the deriver derives, as a timing at which the communication setter starts the setting for enabling communication, a timing at which the setting for enabling communication is able to be completed between reception of the control information transmitted from the application by the control target device and transmission of the next control information.

3. The control device according to claim 1, wherein, in a case where there is a plurality of the control target devices, the deriver derives, as a timing at which the communication setter starts the setting for enabling communication, a timing at which the setting for enabling communication is able to be completed in all the control target devices between reception of the control information transmitted from the application by the control target devices and transmission of the next control information.

4. A server comprising:
an activation instruction receiver configured to activate an application for transmitting control information to a control target device in a virtual machine or a container in accordance with an instruction from a control device; and
a notifier configured to notify the control device of a transmission timing at which the application has transmitted control information to the control target device and a reception completion timing at which the control information has been received by the control target device.

5. A control system comprising a control device and a server, the control device comprising:
an activator configured to cause another virtual machine or another container to activate an application that is activated in a virtual machine or a container constructed in a server and periodically transmits control information to a control target device;
a communication setter configured to perform, in a case where the application has been activated by the activator in the another virtual machine or the another container, setting for enabling communication between the activated application and the control target device; and
a deriver configured to derive, as a timing at which the activator activates the application, a timing at which the setting by the communication setter is not performed between transmission of the control information from the application and reception of the control information by the control target device,
wherein the activator causes the another virtual machine or the another container to activate the application at the timing derived by the deriver,
the server comprising:
an activation instruction receiver configured to activate the application in a virtual machine or a container in accordance with an instruction from the control device; and
a notifier configured to notify the control device of a transmission timing at which the application has transmitted the control information and a reception completion timing at which the control information has been received by the control target device.

6-8. (canceled)
